(19) United States
(12) Patent Application Publication
(10) Pub. No.: US 2008/0082715 A1
(43) Pub. Date: Apr. 3, 2008

(54) DATA TRANSFERS OVER MULTIPLE DATA BUSES

(75) Inventors: James P. Patella, Palm Harbor, FL (US); Nathan P. Moseley, Hillsboro, OR (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/537,152

(22) Filed: Sep. 29, 2006

(51) Int. Cl. G06F 13/36

(52) U.S. Cl. 710/306

(57) ABSTRACT

A method for completing a data transfer over multiple data buses is disclosed. The method involves initiating a transfer of designated data through at least one bridging device and including a data key to immediately follow the data transfer, the data key and the designated data transferred along an identical data path. The method also involves continually transferring at least a portion of the designated data until the data key is received at a destination device.

### BACKGROUND

Direct memory access (DMA) is commonly used for moving blocks of data from a source memory device to a destination memory device. The proximity of a DMA controller to the source memory device minimizes any latency and maximizes throughput of a memory read transaction (the memory read transaction is typically much slower than a memory write transaction). In most situations, the DMA write data transactions are sent through a computer-based network to reach the destination memory device.

When a data transfer involves multiple data buses and/or networks, a bridging device is inserted in the data path to complete the data transfer. Most bridging devices support one or more transaction ordering rules since the data path is typically implemented using FIFO (first-in, first-out) memories. An example of a transaction ordering rule is “writes-cannot-pass-writes.” In this example, write transactions entering a port A (W_{A1}, W_{A2}, W_{A3}, . . . ) of a bridge must exit a port B in the same order (W_{A1}, W_{A2}, W_{A3}, . . . ). A second example of a transaction ordering rule is “read-requests-cannot-pass-read requests.” In the second example, read request transactions entering port A (RREQ_{A1}, RREQ_{A2}, RREQ_{A3}, . . . ) of the bridge must exit the port B in the same order (RREQ_{A1}, RREQ_{A2}, RREQ_{A3}, . . . ). A third example of a transaction ordering rule set is “read-requests-cannot-pass-writes,” but “writes-cannot-pass-read-requests.” In the third example, read request/write transactions entering the port A in the order (RREQ_{A1}, W_{A2}, RREQ_{A3}, W_{A4}, . . . ) of the bridge exit the port B in one of three orders: (W_{A2}, W_{A4}, RREQ_{A1}, RREQ_{A3}, . . . ), (W_{A2}, RREQ_{A1}, W_{A4}, RREQ_{A3}, . . . ), and (RREQ_{A1}, W_{A2}, W_{A4, RREQ}_{A3}, . . . ). Additional examples are found in standard bus topology specifications (for example, a peripheral component interconnect, or PCI, bus specification).

Many bridging devices incorporate a write posting technique to improve performance. Write posting involves buffering continuous memory writes from one or more data buses to the DMA controller while the DMA controller is occupied with other processing. Without write posting, the continuous memory writes from the one or more data buses are not buffered, and each data bus must wait until the DMA controller is free before starting another write cycle. These same bridging devices include write posting FIFO memories to maximize memory transfer throughput.

Other common bridging devices support a limited set of transaction ordering rules due to one or more limitations in a target bus protocol (for example, due to the lack of data bus retry responses). The absence of transaction ordering typically results in unreliable (inconsistent) data transfer orderings into the destination memory device, where the device logic in the destination memory device determines that the memory transfer is complete before all the data is written. These inconsistent data transfers are particularly common during write postings from the source memory device.

### SUMMARY

The following specification addresses data transfers over multiple data buses. In one embodiment, a method for completing a data transfer over multiple data buses is provided. The method involves initiating a transfer of designated data through at least one bridging device and including a data key to immediately follow the data transfer, the data key and the designated data transferred along an identical data path. The method also involves continually transferring at least a portion of the designated data until the data key is received at a destination device.

### DRAWINGS

These and other features, aspects, and advantages will become better understood with regard to the following description, appended claims, and accompanying drawings where:

FIG. 1 is a block diagram of an embodiment of an electronic system for transferring data;

FIG. 2 is a flow diagram illustrating an embodiment of a method for completing a data transfer over multiple data buses; and

FIG. 3 is a block diagram of an alternate embodiment of an electronic system for transferring data.

### DETAILED DESCRIPTION

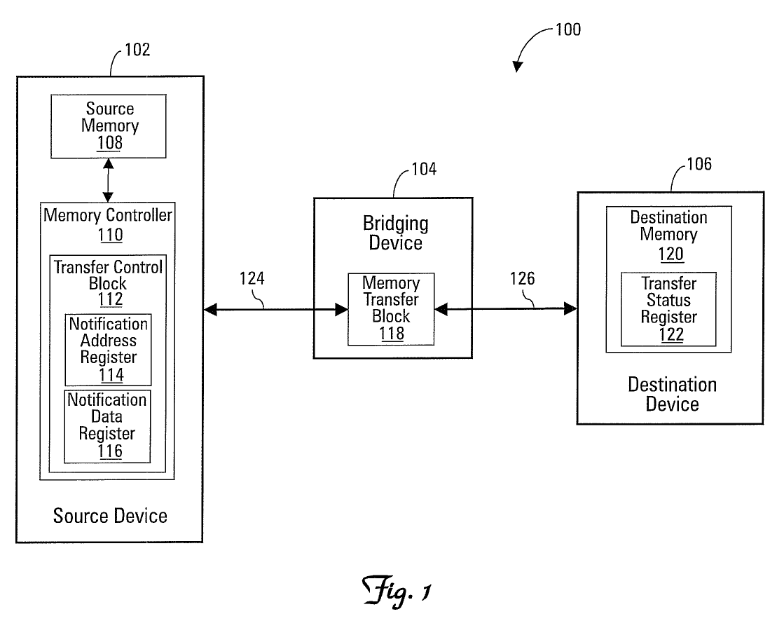

FIG. 1 is a block diagram of an embodiment of an electronic system 100 for transferring data. System 100 comprises a source device 102, a bridging device 104, and a destination device 106. The source device 102 further comprises a source memory 108 coupled to a memory controller 1 10. In the example embodiment of FIG. 1, the memory controller 1 10 is a DMA controller, or the like. The memory controller 1 10 further comprises a transfer control block 1 12. The transfer control block 112 includes a notification address register 114 and a notification data register 116. The destination device 106 comprises a destination memory 120. In the example embodiment of FIG. 1, the destination memory 120 allocates at least one memory register as a transfer status register 122. The bridging device 104 comprises a memory transfer block 118. In one implementation, the memory transfer block 118 comprises one or more FIFO memories, or the like. The source device 102 is coupled to the bridging device 104 by a first data bus 124. The destination device 106 is coupled to the bridging device 104 by a second data bus 126. In the example embodiment of FIG. 1, the first data bus 124 and the second data bus 126 each represent a bidirectional data bus including, without limitation, a serial data bus (for example, a serial peripheral interface, or SPI, bus), and a parallel data bus (for example, the PCI bus). In alternate embodiments, the first data bus 124 and the second data bus 126 comprise non-transaction ordered data buses (that is, data buses that function without any transaction ordering rules).

In operation, the bridging device 104 transfers data from the source memory 108 of the source device 102 to the destination memory 120 of the destination device 106. In the example embodiment of FIG. 1, the bridging device 104 completes the data transfer from the source device 1 02 and the destination device 106 by bridging the first data bus 124 and the second data bus 126 together. In one implementation, the first data bus 124 and the second data bus 126 represent at least two different data bus protocols. The at least two different data bus protocols of the first data bus 124 and the second data bus 126 form a mixed network. In the same implementation, the first data bus 124 supports a first set of transaction ordering rules, with the second data bus 126 supporting a second (different) set of transaction ordering rules. The memory controller 110 completes the data transfer, independent of the first and second sets of transaction ordering rules by calculating a completion word (for example, a unique pattern) to include at the end of the data transfer. The destination device 106 determines if at least a portion (that is, a current portion) of the data contains the unique pattern. Until the unique pattern is read by the destination device 106, the transfer control block 112 conveys additional portions of the data through the memory transfer block 118.

In one implementation, the memory controller 110 stores the completion word in the notification data register 116. In at least one alternate implementation, the completion word is stored in the source memory 108. For every data transfer originating from the source memory 108, the source device 102 (in one implementation) instructs the memory controller 110 to begin the data transfer from the source memory 108 to the destination memory 120. In an alternate implementation, the destination device 106 instructs the memory controller 110 to begin the data transfer from the source memory 108 to the destination memory 120. The data transfer instructions from the source (destination) device 102 (106) further identify a destination memory register (the transfer status register 122) within the destination memory 120. The memory controller 110 records the memory address of the transfer status register 122 in the notification address register 1 14. Prior to each new data transfer, the destination device 106 clears the contents of the transfer status register 122.

At the end of the data transfer, the memory controller 110 writes the completion word to the destination memory register (that is, the transfer status register 122) specified by the notification address register 114. Prior to the end of the data transfer, the memory transfer block 118 transfers one or more additional portions of data from the source memory 108 to the destination memory 120. For each portion of data received, the destination memory 120 continues to read the contents of the transfer status register 122 until the transfer status register 122 contains the completion word. The destination device 106 is capable of determining data transfer status using the transfer status register 122 rather than requesting a status update from (that is, polling) the memory controller 110. In one implementation, once the transfer status register 122 contains the completion word, the destination device 106 informs the memory controller 110 that the data transfer is complete. The transfer control block 112 allows the bridging device 104 to convey multiple data portions from the source device 102 to the destination device 106 through the mixed network of the first data bus 124 and the second data bus 126 independent of one or more data bus transaction orders.

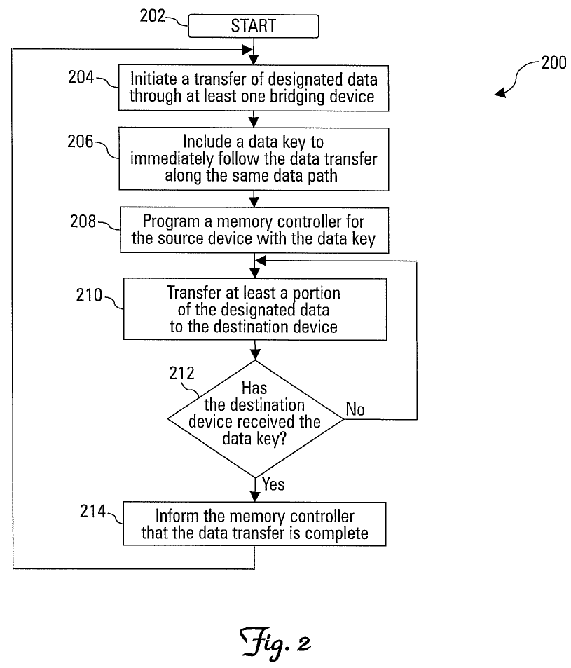

FIG. 2 is a flow diagram illustrating a method 200 for completing a data transfer over multiple data buses. The method of FIG. 2 starts at block 202. The method 200 begins the data transfer at block 204 once the source (destination) data device 102 (106) of FIG. 1 initiates a transfer of designated data from the source memory 108 through the bridging device 104. In one implementation, initiation of the transfer of designated data includes instructing the memory controller 110 to copy a block of data (the designated data) from the source memory 108, beginning at a source starting address, and transfer the block of data to the destination memory 120 for placement beginning at a destination starting address. In one implementation, method 200 maps a memory register address (the transfer status register 122) within the destination memory 120 to receive a data key (for example, the unique pattern discussed above with respect to FIG. 1) at block 204. The inbound memory register address is stored in the notification address register 114 within the transfer control block 112. The method 200 addresses generating the data key in the memory controller 110 to immediately follow the data transfer, with both the data key and the data transferred along an identical data path. In the example embodiment of FIG. 2, the identical data path comprises the first data bus 124 and the second data bus 126. Transferring the data key (completion word) from the notification data register 116 through the identical data path that the data is transferred on (that is, from the first data bus 124 through the memory transfer block 118 and the second data bus 126) guarantees that all previous data writes to the destination memory 120 are flushed through the bridging device 104 (particularly, the write posting FIFOs of the memory transfer block 1 18) before the data key arrives at the transfer status register 122. Detection of the data key in the transfer status register 122 guarantees that all the data is completely written into the destination memory 120 and eliminates unreliable (inconsistent) data transfers.

At block 206, the memory controller 110 includes the data key for placement immediately following the data transfer from the source memory 108. At block 208, the memory controller 110 programs the notification data register 116 with the data key. The memory controller 1 10 transfers at least a portion of the designated data from the source memory 108 to the bridging device 104 at block 210. The method 200 repeats the data transfer at block 210 until the transfer status register 122 receives the data key at block 212, completing the transfer of the designated data. At block 214, the destination device 106 acknowledges receipt of the data key and informs the memory controller 110 that the data transfer is complete before the method 200 repeats another sequence at block 204.

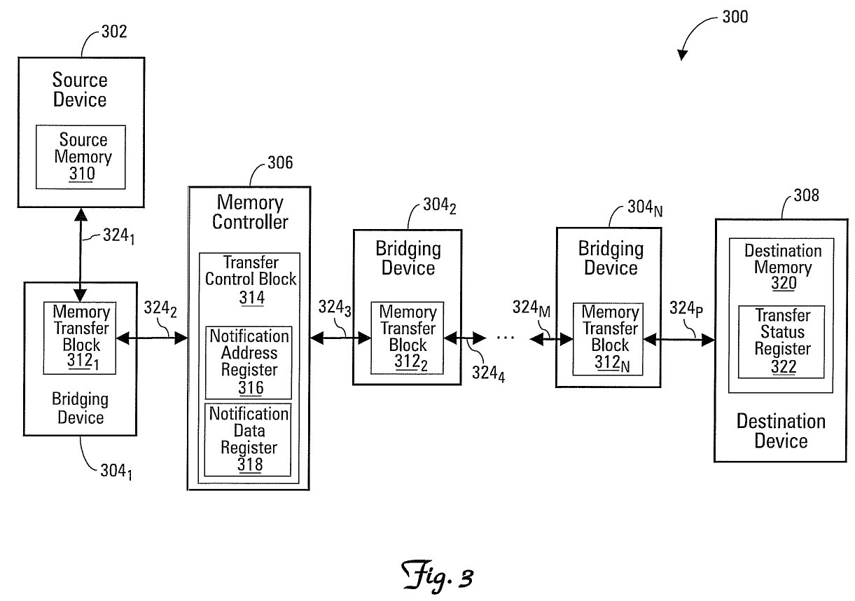

As noted above, FIGS. 1 and 2 illustrate one embodiment of the electronic system 100 and at least one associated operating method 200, respectively. It is to be understood that other embodiments are implemented in other ways. Indeed, the electronic system 100 illustrated in FIGS. 1 and 2 is adaptable for a wide variety of applications. For example, FIG. 3 is a block diagram of an alternative embodiment of the electronic system 100, an electronic system 300. The embodiment of the electronic system 300 shown in FIG. 3 includes at least three bridging devices 304. The three memory banks 304 are individually referenced in FIG. 3 as bridging devices 304₁, 304₂, and 304_{N}, respectively. It is understood that the electronic system 300 is capable of accommodating any appropriate number of the bridging devices 304 (for example, at least one bridging device) in a single electronic system 300. Each of the bridging devices 304₁ to 304_{N} further comprise a memory transfer block 312₁ to 312_{N}, respectively.

In the example embodiment shown in FIG. 3, the electronic system 300 further comprises a source device 302, a memory controller 306, and a destination device 308. The source device 302 comprises a source memory 310. In the example embodiment of FIG. 3, the source device 302 is coupled to the memory controller 306 by the bridging device 304, and data buses 324, and 3242. The memory controller 306 further comprises a transfer control block 314. The transfer control block 314 includes a notification address register 316 and a notification data register 318. The destination device 308 comprises a destination memory 320. In the example embodiment of FIG. 3, the destination memory 320 allocates at least one memory register as a transfer status register 322. The memory controller 306 and the destination device 308 are communicatively coupled to the series of bridging devices 304₂ to 304_{N} through data buses 324₃ to 324_{P}. Similar to the example embodiment of FIG. 1, the data buses 324₁ to 324_{P} form a mixed network of data buses. In one implementation, each of the data buses 324₁ to 324_{P} represents one or more bidirectional data communication buses of differing data bus protocols. Alternate implementations are possible.

In operation, the bridging devices 304₁ to 304_{N} transfer data from the source memory 310 in the source device 302 through the memory controller 306 to the destination memory 320 in the destination device 308. In the example embodiment of FIG. 3, the bridging devices 304₁ to 304_{N} complete the data transfer from the source device 302 to the destination device 308 by bridging the data buses 324₃ to 324_{P} together. In one or more implementations, the data buses 324₃ to 324_{P} support at least one different set of bridge device transaction ordering rules. The memory controller 306 completes the data transfer, independent of all bridge device transaction ordering rules by calculating a completion word (for example, a unique pattern) to include at the end of the data transfer. The destination device 308 determines if at least a portion (a current portion) of the data contains the unique pattern. Until the unique pattern is read by the destination device 308, the transfer control block 314 conveys additional portions of the data through the corresponding memory transfer blocks 312₁ to 312_{N}.

In one implementation, the memory controller 306 stores the completion word in the notification data register 318. In at least one alternate implementation, the completion word is stored in the source memory 310. For every data transfer originating from the source memory 310, the source device 302 (in one implementation) instructs the memory controller 306 to begin the data transfer from the source memory 310 to the destination memory 320. In an alternate implementation, the destination device 308 instructs the memory controller 306 to begin the data transfer from the source memory 310 to the destination memory 320. The data transfer instructions from the source (destination) device 302 (308) further identify a destination memory register (the transfer status register 322) within the destination memory 320. The memory controller 306 records the memory address of the transfer status register 322 in the notification address register 316. Prior to each new data transfer, the destination device 308 clears the contents of the transfer status register 322.

Similar to the operation outlined above with respect to FIG. 1, the memory controller 306 writes the completion word to the destination memory register (that is, the transfer status register 322) specified by the notification address register 316 at the end of the data transfer. Prior to the end of the data transfer, each of the memory transfer blocks 3121 to 31²N transfer one or more additional portions of data from the source memory 310 to the destination memory 320. For each portion of data received, the destination memory 320 continues to read the contents of the transfer status register 322 until the transfer status register 322 contains the completion word. The destination device 308 is capable of determining data transfer status using the transfer status register 322 rather than requesting a status update from (that is, polling) the memory controller 306. In one implementation, once the transfer status register 322 contains the completion word, the destination device 308 informs the memory controller 306 that the data transfer is complete. The transfer control block 314 allows the bridging devices 304₁ to 304_{N} to convey multiple data portions from the source device 302 to the destination device 308 through the mixed network of the data buses 324₁ to 324_{N} independent of one or more data bus transaction orders.

The methods and techniques described here may be implemented in one or more programs that are executable on a programmable system including at least one programmable processor coupled to receive data and instructions from (and to transmit data and instructions to) a data storage system, at least one input device, and at least one output device using (in one implementation) direct memory access, and the like. Generally, a processor will receive instructions and data from a read-only memory and/or a random access memory. Storage devices suitable for tangibly embodying computer program instructions and data include all forms of non-volatile memory, and including by way of example, semiconductor memory devices; EPROM, EEPROM, and flash memory devices; magnetic disks such as internal hard disks and removable disks; magneto-optical disks; and DVDs. Any of the foregoing may be supplemented by, or incorporated in, specially-designed electronic computing elements comprising application-specific integrated circuits (ASICs), field-programmable gate arrays (FPGAs), and the like.

This description has been presented for purposes of illustration, and is not intended to be exhaustive or limited to the form (or forms) disclosed. Variations and modifications may occur, which fall within the scope of the embodiments described above, as set forth in the following claims.

What is claimed is:

1. A method for completing a data transfer over multiple data buses, the method comprising:
initiating a transfer of designated data through at least one bridging device;
including a data key to immediately follow the data transfer, the data key and the designated data transferred along an identical data path; and continually transferring at least a portion of the designated data until the data key is received at a destination device.

2. The method of claim 1, wherein initiating the transfer of the designated data further comprises mapping to an inbound memory register address in the destination device.

3. The method of claim 1, wherein including the data key to immediately follow the data transfer further comprises programming a memory controller with the data key.

4. The method of claim 1, wherein continually transferring the portion of designated data further comprises acknowledging when the destination device receives the data key.

5. The method of claim 4, wherein acknowledging when the destination device receives the data key comprises reading the data key directly at the destination device.

6. The method of claim 1, and further comprising completing the data transfer using direct memory access.

7. An electronic system, comprising:
a memory controller, the memory controller comprising: a transfer control block programmable to contain a completion word;
at least one source memory responsive to the memory controller;
at least one destination memory, the at least one destination memory responsive to the memory controller; and
one or more bridging devices that bridge one or more mixed network data buses between the at least one source memory and the at least one destination memory and transfer data from the at least one source memory to the at least one destination memory over a single data path independent of one or more data bus transaction orders.

8. The system of claim 7, wherein the memory controller is a direct memory access memory controller.

9. The system of claim 7, wherein the transfer control block further comprises: a notification data register that stores the completion word; and a notification address register that identifies a destination for the completion word in the at least one destination memory.

10. The system of claim 7, wherein the at least one source memory and the memory controller reside in a single source device.

11. The system of claim 7, wherein the at least one destination memory further comprises a transfer status register.

12. The system of claim 11, wherein the transfer status register receives the completion word once the data transfer between the at least one source memory and the at least one destination memory is complete.

13. The system of claim 7, wherein the one or more bridging devices comprises a memory transfer block.

14. The system of claim 13, wherein the memory transfer block comprises a first-in, first-out memory configuration.

15. The system of claim 7, wherein the at least one destination memory initiates the data transfer over the single data path.

16. The system of claim 7, wherein the memory controller, the at least one source memory, the at least one destination memory, and the at least one bridging device reside on a single electronic computing element.

17. A program product comprising program instructions, embodied on a storage medium, that are operable to cause at least one programmable processor included in a programmable system to:
transfer a current portion of data through at least one bridging device independent of transaction ordering rules;
determine if the current portion of the data contains a unique pattern; and
convey one or more additional portions of the data through the at least one bridging device until the unique pattern is read by a destination device.

18. The program product of claim 17, wherein the instructions operable to transfer the current portion of data through at least one bridging device cause the at least one programmable processor to:
store the unique pattern as a completion word; and
identify a destination address for the completion word at the destination device.

19. The program product of claim 18, wherein the instructions operable to identify the destination address for the completion word cause the at least one programmable processor to write the completion word to a memory register corresponding to the destination address at the end of the data transfer.

20. The program product of claim 17, wherein the instructions operable to convey one or more additional portions of the data through the at least one bridging device cause the at least one programmable processor to receive confirmation that the data transfer is complete once the destination device contains the unique pattern.
